(19) United States
(12) Patent Application Publication
(10) Pub. No.: US 2004/0059978 A1
(43) Pub. Date: Mar. 25, 2004

(54) Reduced latency for recovery from communications errors

(76) Inventor: Parvathanathan Subrahmanya, Sunnyvale, CA (US)

Correspondence Address: Qualcomm Incorporated, Patents Department, 5775 Morehouse Drive, San Diego, CA, 92121-1714, US

(21) Appl. No.: 10/600,147

(22) Filed: Jun. 19, 2003

Related U.S. Application Data
(60) Provisional application No. 60/391,985, filed on Jun. 25, 2002.

(51) Int. Cl. H04L 1/18; G08C 25/02

(52) U.S. Cl. 714/748

(57) ABSTRACT

Methods and apparatus for reducing latency for communication error recovery includes recognizing that an incoming message is due, and requesting retransmission if that message is not properly received. A message is transmitted as two message portions, the first message portion transmitted at a first power level, and the second message portion, which is associated with the first message portion, transmitted at a second lower power level. The first power level is chosen to provide a predetermined probability that the first message portion will be successfully received. Alternatively, the first and second message portions are transmitted such that the first message portion has a greater energy per bit than does the second message portion. At a first time, the first message portion is received. At a second time, wherein the second time has a known relationship to the first time, a signal is received from which the second message portion is not reliably obtained. The receiving device recognizes that the second message portion was not properly received and requests retransmission of at least the second message portion.

### RELATED APPLICATIONS

This application claims the benefit of prior filed provisional application 60/391,985, filed on Jun. 25, 2002.

### FIELD OF THE INVENTION

The present invention relates to the field of communications. More particularly, the invention relates to reducing latency for error recovery in communications.

### BACKGROUND OF THE INVENTION

In any communications system, when information is transmitted from one location to another, errors can be introduced during the communications process. As a result, communication systems are typically designed with one or more facilities that provide an ability to correct, or otherwise recover from, such errors. These error recovery techniques provide for a greater level of data integrity.

Two general methods of error control and recovery employed in communication systems, are Forward Error Correction (FEC), and Automatic Repeat Request (ARQ). In the FEC methodology, error correction bits are transmitted along with the data of interest. These error correction bits allow a receiving unit to correct a certain number of errors introduced during the transmission process, thereby reconstructing the original data. However, due to the overhead associated with FEC, this methodology is typically limited to communication system scenarios where retransmission is impossible or impractical. ARQ error recovery methodologies generally involve detecting an error in received data, and, in view thereof, requesting that that data be retransmitted. FEC and ARQ methodologies can also be used in combination, such as where ARQ (i.e., retransmission of data received with errors) is used to overcome the errors that could not be corrected by FEC methods.

To facilitate an understanding of error control methodologies such as ARQ, it is helpful to refer to the well-known Open Systems Interconnect (OSI) model which has been published by the International Standards Organization (ISO). The OSI model includes seven layers, which are referred to as the physical layer, the data link layer, the network layer, the transport layer, the session layer, the presentation layer, and the application layer. The OSI seven layer model defines standards such that compliant systems are interoperable with each other. In the OSI model the physical layer defines the standards required for physical interconnections, while the data link layer defines the protocols for exchanging data frames over the physical layer, and the network layer deals with routing pieces of information to their intended recipients. In common usage, those portions of a system that perform the functionality specified by a layer of the OSI model are referred to by that layer name. For instance, that hardware, or hardware/software combination, that achieves the data link layer functionality is often simply referred to as the data link layer.

Using the Open Systems Interconnect model as a framework to discuss error control, it can be said that ARQ is performed at the data link layer of the OSI model. The data link layer is, among other things, responsible for ensuring that the data received from the physical link is error-free. By performing this function, the data link layer ensures that the data provided to the network layer is free from errors. The following example refers to a frame-originating unit and a frame-receiving unit, each with its respective physical, data link, network, and other layers. It is noted that both the frame-originating unit and the frame-receiving unit of this example, are each capable of transmitting and receiving. Typically the data link layer of a frame-originating unit is provided with data by its network layer, and organizes that data into frames for transmission. The data link layer of the frame-originating unit also typically generates error detection information, such as bits in accordance with a cyclic redundancy check (CRC) code, for each frame of data to be transmitted. The frame, along with the CRC bits, are then passed to the physical layer for transmission. At the frame-receiving unit, the physical layer receives the frame and CRC bits, which are then passed to the data link layer of the frame-receiving unit. The frame-receiving unit data link layer calculates an expected CRC based on the received frame and compares the calculated CRC value to the CRC bits received with the frame. If the two CRC values do not match, then the frame-receiving unit data link layer requests that the transmitting unit data link layer retransmit the appropriate frame(s).

In this field, the term latency generally refers to a period of time between a first, triggering event, and a second, responsive event. As used herein, latency refers to the period of time bounded by the start of a transmission of a frame, and the start of a request for retransmission.

The latency associated with the above-described ARQ process is dependent upon a variety of system design parameters. Consider an illustrative system in which a protocol is in use that provides for each user to transmit a frame, in turn, once every 300 milliseconds. Additionally, at the data link layer of this illustrative system, the protocol calls for tracking frames of data by sequence numbers. In accordance with this protocol, the data link layer determines that a frame is missing when a frame having an unexpected sequence number is received. The receipt of a frame with an unexpected sequence number indicates that at least one previously transmitted frame was not properly received. Unfortunately, at least 300 milliseconds will have elapsed, in this example, since the missing frame was transmitted, as the data link layer must wait for a properly received frame with an unexpected sequence number in order to recognize a missed frame.

The time required, or latency, to begin an error recovery operation in the above-described example, is constrained by the requirement to receive a frame of data which can be interpreted, subsequent to the one or more frames that were received in error.

What is needed are methods and apparatus for improving the efficiency of communications systems by reducing the latency in error recovery operations.

### SUMMARY OF THE INVENTION

Briefly, methods and apparatus for reducing the latency of error recovery in communication systems include recognizing that an incoming message is due, and requesting retransmission if that message is either not received, or received with errors. In accordance with the present invention, a message is transmitted in at least two message portions, including a first message portion transmitted at a first power level, and a second message portion, which is associated with the first message portion, transmitted at a second, lower, power level. The first power level is chosen to provide a predetermined probability that the first message portion will be successfully received. At a first time, the first message portion is received. At a second time, wherein the second time has a known relationship to the first time, a signal is received from which the second message portion is not reliably obtained. The receiving device recognizes that the second message portion was not properly received and requests retransmission of at least the second message portion.

A transmitting unit, in accordance with the present invention, transmits a message in at least two parts. A first part is transmitted at a first power level, and a second part is transmitted at a second power level that is lower than the first power level. The first message portion may include a portion of the data to be transmitted, or the content of the first message portion may be independent of the data to be transmitted. In some embodiments, the transmitting unit is also capable of receiving and processing signals.

A receiving unit, in accordance with the present invention, is adapted to receive a first message portion at a first time, the first message portion having a first energy per bit. The receiving unit is further adapted to receive a signal, at a second time, which has a known relationship to the first time. In the event that a second message portion is not reliably obtained from the signal, which is expected at the second time, a request is made by the receiving unit for at least the second portion to be retransmitted. The second message portion is associated with the first message portion. In an alternative embodiment, responsive to the non-receipt of the second message portion, a negative acknowledgement is provided by the receiving unit. The negative acknowledgement is typically communicated to the transmitting unit from which the attempt to transmit the second message portion was made. If the second message portion is received without errors, then an error recovery procedure is not initiated.

In some alternative embodiments, the energy per bit of the received first and second message portions is determined at least in part by the coding and modulation technique, rather than being determined solely by transmit power.

### BRIEF DESCRIPTION OF THE DRAWINGS

The features, objects, and advantages of the present invention will become more apparent from the detailed description set forth below when taken in conjunction with the drawings in which like reference characters identify like elements throughout.

FIG. 1 illustrates a communications system to which the present invention is applicable.

FIG. 2 is a flow diagram of a method of transmitting a message in at least two portions, each portion being transmitted at a different power level in accordance with one embodiment.

FIG. 3 is a flow diagram of a method of transmitting in accordance with one embodiment.

FIG. 4 is a flow diagram showing the handling by a receiving device of a transmitted message.

FIG. 5 is a flow diagram of operations performed by a receiving device wherein the second message portion is successfully received.

FIG. 6 is a flow diagram of operations performed by a receiving device wherein the second message portion is received with errors.

FIG. 7 is a flow diagram of operations performed by receiving device wherein the second message portion is received with errors.

### DETAILED DESCRIPTION

Generally, methods and apparatus for reducing the latency involved in requesting the retransmission of data that is received with errors, or not received at all, provide for recognizing that a retransmission of data is required sooner than occurs in conventional wireless communication systems. In accordance with the present invention, a first message portion is transmitted in a manner such that it has a higher probability of being successfully received than does an associated second message portion. Receipt of the first message portion informs the receiving unit that the second message portion, which has a known timing relationship to the first message portion, is to be received. If the second message portion is not received, or is received with errors, then a request for retransmission may be made.

Various illustrative embodiments of the present invention are discussed in detail below. While specific steps, configurations, and arrangements are discussed, it should be understood that this is done for illustrative purposes only. A person skilled in the relevant art will recognize that other steps, configurations, and arrangements can be used without departing from the spirit and scope of the present invention.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

Exemplary Operating Environment

Various embodiments find application in wireless communication systems including both terrestrial, and satellite-based, wireless communication systems.

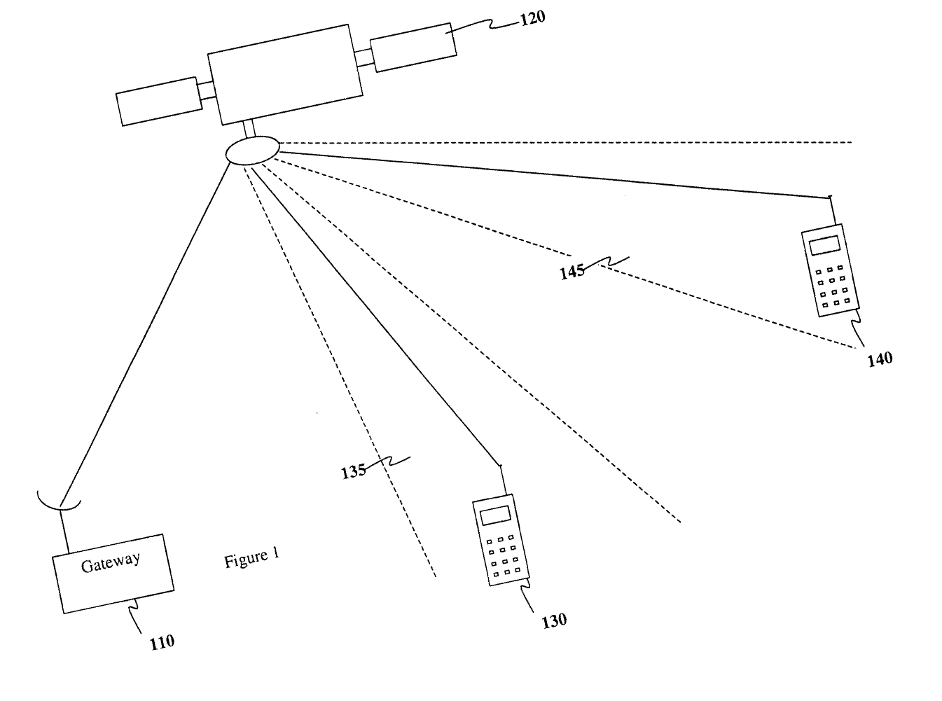

Referring now to FIG. 1, a gateway 110 transmitting forward channel data to user devices 130, 140 through communications satellite 120 is shown. The terms base station and gateway are sometimes used interchangeably in this field, with gateways being perceived as specialized base stations that direct communications through satellites, while base stations use terrestrial antennas to direct communications within a surrounding geographical region. User devices are also sometimes referred to as subscriber units, user terminals, access terminals, mobile units, mobile stations, or simply “users”, “mobiles”, “subscribers”, or the like. User devices 130, 140 transmit reverse channel data to gateway 110 through satellite 120. Communications satellites form beams, here shown as 135 and 145, that illuminate a “spot”, or area produced by projecting satellite communications signals onto the Earth's surface. A typical satellite beam pattern for a spot comprises a number of beams arranged in a predetermined coverage pattern. Typically, each beam comprises a number of so-called sub-beams covering a common geographic area.

For purposes of providing an illustrative description, reference is made herein to a first formatted data structure referred to as a packet, and a second formatted data structure referred to as a frame, wherein the frame includes one or more packets. The packets are smaller units of data, and each packet is typically associated with a single transmitting device. It is noted that the nomenclature used to refer to the variously organized, or formatted, groupings of data do not limit the invention in any way.

In the context of wirelessly transmitted data, formatted such that the data has known organizational characteristics (often referred to using terms such as frames or packets), errors may be categorized into two broad types. A first type of error is one in which a signal is received by a receiving device from which at least one packet of data is obtained and in which that packet contains an error. This first type of error is conventionally handled by methods such as FEC and/or ARQ. A second type of error is one in which the quality of the signal may be so poor that the receiving device does not recognize that an attempt to deliver data has been made. This second type of error is conventionally handled by way of ARQ only after a subsequent transmission is received from which it can be determined that a packet or frame is missing.

In wireless communication systems, a data-containing signal may suffer from various effects between transmitter and receiver which make the data unrecoverable from the signal. Such effects may include, but are not limited to, noise and attenuation. If these effects make it not possible for a receiver to properly demodulate a transmitted signal, then the receiver will conventionally detect this error at the data link level when the missing frame is noticed. In other words, in instances of severe signal degradation, the physical layer cannot obtain data from an incoming signal, and hence the data from that degraded signal is not delivered to the data link layer. When a subsequent signal of sufficient quality to be processed by the receiver of the physical layer arrives and is demodulated, the resulting information that is provided to the data link layer can be used therein to determine that some earlier transmitted data has not arrived. This is the time in conventional systems that a request to retransmit the missing data is made. Unfortunately, the latency involved in requesting the retransmission of data in such a conventional manner places certain constraints on system performance.

As noted above, embodiments of the present invention provide for reducing the latency involved in requesting the retransmission of data that is received with errors, or not received at all. In accordance with one embodiment, a first message portion has a higher probability of being successfully received than does a second message portion. Receipt of the first message portion informs the receiving unit that an associated second message portion, which has a known timing relationship to the first message portion, is to be received. If the second message portion is not received, or is received with errors, then a request for retransmission is made.

More particularly, in accordance with the present invention, the physical layer is used to determine whether there is a need to request a retransmission. Referring to FIG. 1, an overview of the operational aspects of various embodiments of the present invention are described. In an illustrative wireless communication system, a receiving unit attempts to demodulate a signal. In one embodiment, gateway 110 acts as a receiving unit for data transmitted on the reverse link by user device 130. Gateway 110 receives a first signal from user device 130. The first signal may contain information, or it may be a signal unmodulated by data. The first signal may be referred to as a side information signal or as a first message portion signal. Typically, the first signal is transmitted in such a way that it has a higher probability of being received by gateway 110 than does an associated second signal. Ensuring a higher probability of being successfully received may comprise transmitting the first signal at a higher power level than that of the second signal. Alternatively, the first signal may be modulated with a lower order modulation scheme. In further alternatives, various combinations of data rate, modulation, and transmit power may be used to provide a higher probability of successful reception at gateway 110 for the first signal as compared to the second signal. In one embodiment, the side information signal is transmitted at a sufficient power level (or at a sufficient energy per bit) such that there will be less than a 10⁻⁹ probability that the side information signal will not be detected at gateway 110.

The first signal is typically, but not required to be, shorter in duration than the second signal. Reception of the first signal indicates that a second signal should also be received by gateway 110. If the second signal is not received within a known timing relation to the first signal, or the second signal is received but errors are detected in the data obtained therefrom, then gateway 110 may initiate a request for retransmission of the second signal by user device 130. The request for retransmission is typically made by gateway 110 transmitting a message to user device 130 indicating that retransmission is to be performed. In this way, user device 130 is able to retransmit earlier than is accomplished conventionally, because it is not necessary to wait until a higher layer, e.g., the data link layer, recognizes that information is missing.

The side information signal may be any signal that is transmitted in association with a primary signal. As used herein, the side information signal is typically referred to as the first signal, and the primary signal is typically referred to as the second signal. In one embodiment, the side information signal contains a first portion of a message to be transmitted, and the second signal contains a second portion of that message. In another embodiment, the side information signal contains administrative or overhead information. In still another embodiment, the side information signal is unmodulated by data.

While it may be desirable to transmit the primary signal itself (i.e., the second message portion) at the higher power level, to do so may result in an unacceptable level of power consumption, interference, unlicensed aggregate transmit power for a communication system, or various combinations thereof. However, if the side information signal is small, i.e., of short duration as compared to the primary signal, then the power consumed by the higher power transmission of the side information signal is relatively low. Similarly, interference and unlicensed aggregate transmit power issues associated with transmitting both the first and second message portions at the higher power level are avoided.

In one embodiment, when gateway 110 notes the presence of a side information signal (e.g., a first message portion), without the corresponding primary signal (e.g., a second message portion), gateway 110 takes steps to request a retransmission from user device 130. To facilitate identification of the data to be retransmitted, the system associates identifying information with the message data. In one embodiment, frame sequence numbers, which identify frames of data, are used to identify the missing or erroneous frames that are to be retransmitted.

In some instances, gateway 110 may not know which sequence number or other identifier, was being transmitted and not received. This may result since the message portion that was not received may contain the sequence number. In one embodiment in use in a CDMA system, a receiving unit, e.g., gateway 110, is synchronized in time through the use of time information gathered from the Global Positioning System (GPS). Further, every frame that gateway 110 transmits is associated with a system frame number (SFN). Every chip (PN code) that the gateway transmits is associated with a psuedo noise (PN) count. Thus, the SFN and PN together determine time to a very high degree of precision. SFN is typically transmitted in units of several milliseconds. In an exemplary system, SFN is specified as a multiple of 10 ms modulo 2.56 seconds. PN count is typically specified in units of microseconds or nanoseconds. In an exemplary system, PN count is specified as a multiple of 260 ns modulo 10 ms. For example, PN count=4 and SFN=5 together define the instant of time precisely as:

time=SFN*10 ms+PN*260 ns=50001040 ns, accurate to within 260 ns

This enables each transmitting unit to have an accurate indication of time. As a result, in such an embodiment, when user device 130 transmits data, it has the ability to store a transmission timestamp along with the data. In this illustrative embodiment, gateway 110 knows the time of reception of both frames of data, and of the side information signals. Gateway 110 also generally knows the round trip delay to the user terminal. Using the time of reception and the round trip delay, gateway 110 can determine the time of transmission of a missing frame. In this embodiment, in the case where gateway 110 determines that a frame was sent but not properly decoded, gateway 110 provides two pieces of information to user device 130. The first piece of information is the time of transmission of the last properly received frame. The second is the time of transmission of the frame that was not received, but whose side information signal was detected. Thus, gateway 110 provides to user device 130 a negative acknowledgement (NAK) packet that includes the transmission times of the last properly received frame and the frame that was missed.

In one embodiment, when user device 130 transmits a frame to gateway 110, user device 130 saves the frame and records a timestamp indicating when the frame was transmitted. User device 130 includes a buffer memory to maintain a sufficient history of frame transmission data to be able to provide a reasonable number of previously transmitted frames. After receiving the NAK packet including the transmission time of the last properly received frame from gateway 110, user device 130 looks in the history of frame transmissions and determines which frames were transmitted since the last properly received frame. User device 130 then retransmits to gateway 110 those frames which were not properly received by gateway 110. In one embodiment, these retransmitted frames are sent with a higher E_{b}/Nₒ than the original, missed frame transmission. By so doing, the probability of being received by gateway 110 is increased.

Transmitting Device Performance

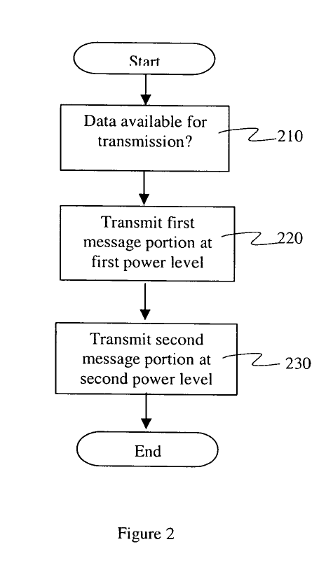

Referring now to FIG. 2, wherein one embodiment of a method of transmitting a side information signal is shown. User device 130 determines that it has a message for transmission 210. The source of the message that user device 130 desires to transmit is not material to the present invention. The message may be received from an application program, may be generated internally by user device 130, may be received from an external source, or may become available by any other suitable means. Upon such determination that a message is ready for transmission, user device 130 transmits a first message portion at a first power level 220. The power level of transmission along with other factors will determine a probability of successful reception of the first message portion by gateway 110. In addition to transmitting the first message portion, user device 130 will transmit a second message portion at a second power level 230. The power level of transmission of the second portion, along with other factors, determines a probability of successful reception of the second message portion. In one embodiment, the power level for the transmission of the first message portion is greater than the power level for the transmission of the second message portion. In another embodiment, the probability of successful reception by the receiving device is higher for the first message portion than the probability of successful reception of the second message portion. It is noted that although the illustrative embodiment of FIG. 2 makes use of different transmit power levels, any suitable scheme that provides a greater probability of successful reception for the first message portion, such as providing more energy per bit, may be used.

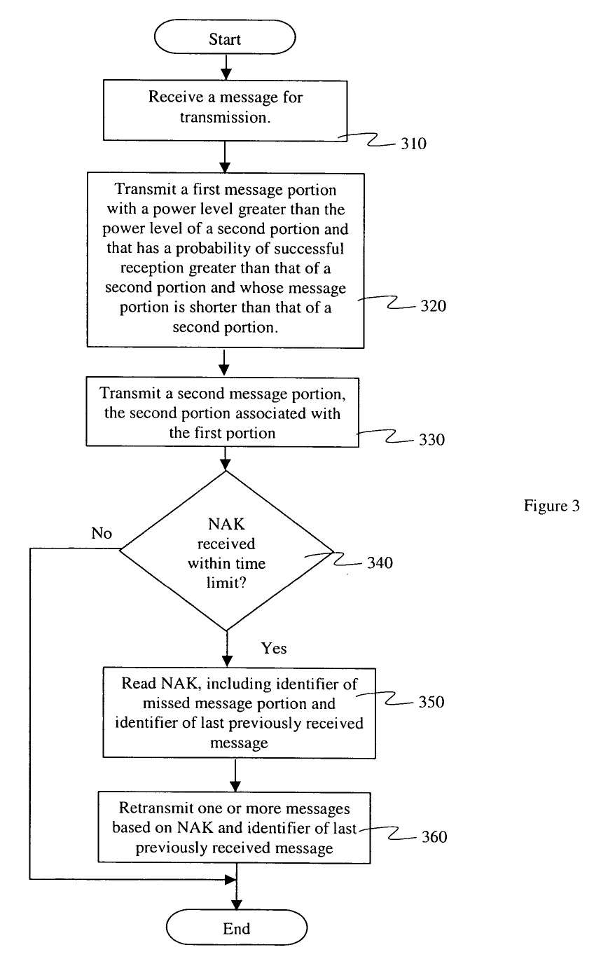

FIG. 3 is a flowchart of an illustrative method of transmitting in accordance with the present invention. User device 130 receives a message from the data link layer for transmission 310. User device 130 transmits a side information message at one power level as the first message portion 320. In addition, user device 130 transmits the remainder of the message in a second message portion at a second power level 330. In this illustrative embodiment, the power level is adjusted on the first message portion to transmit at a higher power level than that of the second message portion. This higher power level transmission, results in a higher probability of successful reception at a receiving device for the first message portion than for the second message portion. The first message portion is also of a shorter length, or duration, than is the second message portion. By having the first message portion be of a shorter length, the transmitting energy requirements for the first message portion, while at a higher power per bit, can be kept low. In one embodiment, the high power first message portion is part of a preamble to the message received from the data link layer. Several bits of the preamble are transmitted, as the first message portion, at a higher power level than the remaining portion of the message, which is the second message portion. In this embodiment, when the transmitting device sends the message, it saves a copy of the message in a local memory along with a corresponding timestamp, or similar identifying indicia. The transmitting device maintains a history of the last N frames sent in a memory device along with the transmitted timestamps. As illustrated in this embodiment, the side information signal can be a portion of the message received from the data link layer. In other embodiments, the side information signal may be a signal transmitting identifying information not related to the message received from the data link layer.

After transmitting the first and second message portions, user device 130 determines whether a NAK has been received from receiving device 340. If a NAK is not received within a predetermined amount of time, then user device 130 has successfully completed the transmission of the message. If, however, in this embodiment, a NAK is received, the NAK will contain information from gateway 110 on the identity of the last successfully received frame and the missing frame 350. In one embodiment, this information is identified by transmission timestamps of the last successfully received message as well as of the missing frame. User device 130 determines from the timestamps, by looking in the memory containing the last saved N frames and timestamps, the last successfully received message as well as the missed message. User device 130 then re-transmits the stored frames to gateway 130 starting with the frame after the last successfully received message up to, and including, the missed frame 360.

Receiving Device Performance

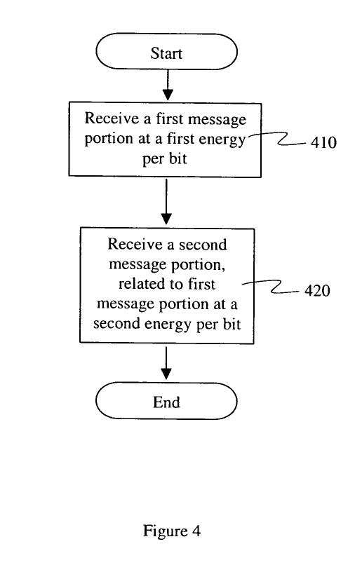

FIG. 4 is a flow diagram of the operations performed by an illustrative receiving device in accordance with the present invention. The receiving device receives 410 a first message portion at a first energy per bit. The receiving device receives 420 a second message portion, related to the first message portion, and having a known timing relationship to the first message portion, at a second energy per bit. In one embodiment, the first message portion, in addition to providing an indication that a second related message portion should be received, also includes a portion of the data being transmitted by a user device. In such an embodiment, the second message portion contains the remainder of the relevant message data.

It is noted that there is no temporal requirement that the first signal be received prior to the second signal. The first signal may be transmitted subsequent to, or concurrently with the second signal. The first signal and the second signal may access a transponder by way of time division multiple access, frequency division multiple access, code division multiple access, or any other suitable means.

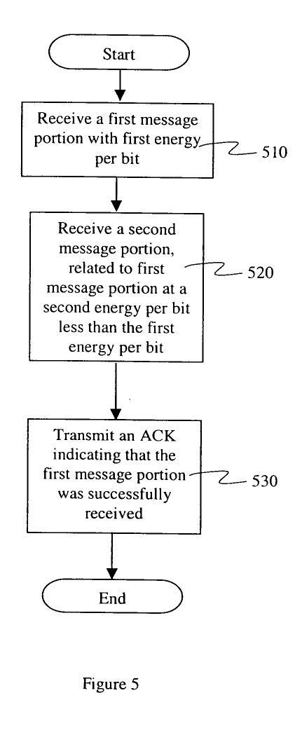

FIG. 5 is a flow diagram of operations performed by an illustrative receiving unit in accordance with the present invention. In this embodiment, a receiving unit, such as gateway 110, receives 510 a first message portion. The first message portion is received with a first energy per bit. The receiving unit also receives 520 a second message portion. In the illustrative embodiment of FIG. 5, the second message portion is related to the first message portion. The second message portion is received at a lower energy per bit as compared to the first message portion. In response to receiving the second message portion, an acknowledgement (ACK) indicating that the second message portion was successfully received is transmitted 530. In this illustrative embodiment, it is intended that the acknowledgement be received by the device from which the first and second message portions originated. In some embodiments the acknowledgment packet includes a timestamp. In various embodiments, the timestamp may be indicative of the time at which the second message portion was sent, or when it was received. In other embodiments, the transmission of an acknowledgment is not required.

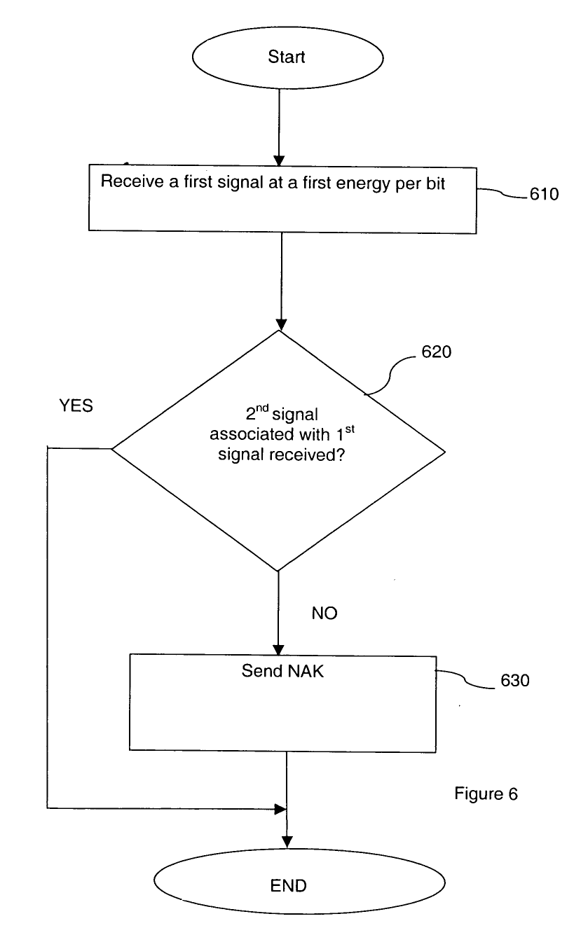

FIG. 6 is a flow diagram of the operations performed by an illustrative receiving unit in accordance with the present invention when the second message portion is not reliably received. In this illustrative example, the receiving unit receives 610 a first signal from which the first message portion is obtained at a first energy per bit. However, the receiving unit may then receive a second signal from which a second message portion, associated with the first message portion, cannot be reliably obtained. For example, if, in an attempt to demodulate a signal carrying the second message portion, the receiving unit is unable to properly demodulate the signal due to a low signal to noise ratio, the second message portion cannot be successfully obtained. A determination is made 620 as to whether the second signal associated with the first signal in a known temporal relation has been received. If the determination at 620 is affirmative, then the illustrative process of FIG. 6 ends. However, if the determination at 620 is negative, then a NAK is sent at 630 to the device from the first message portion was received.

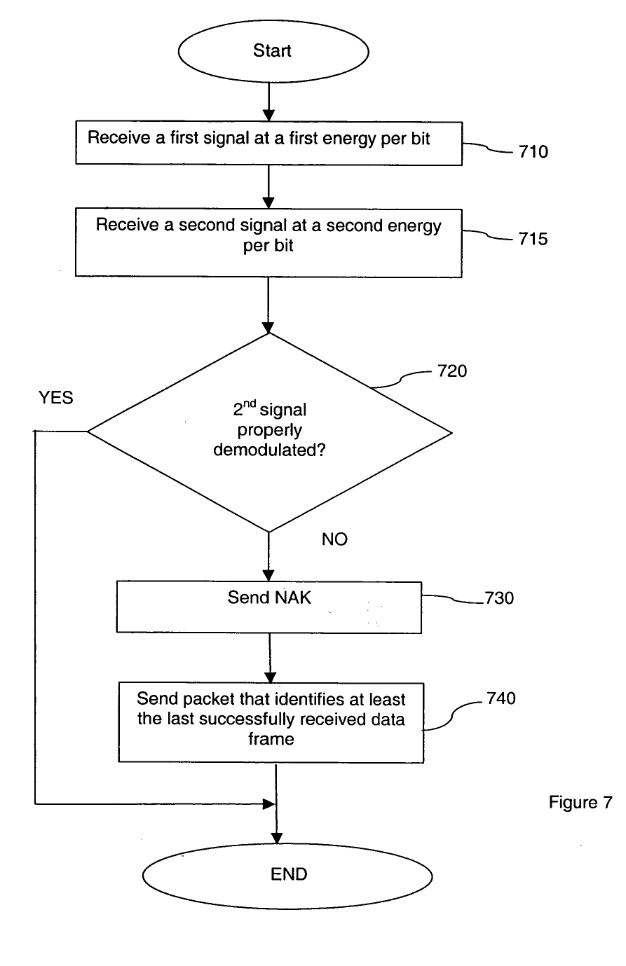

FIG. 7 is a flow diagram of an alternative set of operations performed by a receiving unit wherein the second message portion is not reliably received. A first signal is received 710 from which the first message portion is obtained at a first energy per bit. A signal is presented to the receiving unit from which the second message portion cannot be correctly obtained 715. In this example, upon detection that a second message portion, which is associated with the first message portion, was not successfully received 720, a negative acknowledgement (NAK) packet is sent 730 to the message-originating user device. In this illustrative embodiment, the NAK packet includes an indicator which identifies the frame that was not successfully received. In addition to identifying the missing frame, the receiving unit also identifies the last successfully received frame of data. The receiving unit then sends 740 the information identifying the last successfully received frame to the transmitting device. As previously discussed, various methods of identifying the missing frame may be used. In this embodiment, the receiving unit maintains a record of the last successfully received message along with frame identification information that is suitable for interpretation by the message-originating transmitting unit. In this way, the transmitting unit can determine which data is required to be retransmitted, if any.

System Level Operation

Referring to FIG. 1, user device 130 sends a first and second message portion to gateway 110. In some embodiments, if the transmissions are successfully received, gateway 110 sends an acknowledgement (ACK) back to user device 130 indicating the successful reception. If, however, the transmission is not successfully received by gateway 110, and gateway 110 detects the unsuccessful transmission, gateway 110 can request that user device 130 resend the appropriate messages. Gateway 110 determines that a frame is not successfully received when it receives the first portion of a message but does not receive the corresponding second portion of the message.

In the embodiment shown, after receiving the transmissions and determining that the second message portion was not successfully received, gateway 110 performs the operations needed to transmit a NAK packet to the message-originator. The computational resources required for making such a determination are relatively small, and in one embodiment, the determination that a NAK is to be sent is made within tens of microseconds of the second portion being missed. Gateway 110 then schedules the NAK packet for transmission on the forward link. In a packet data system, this NAK packet would be put into a scheduling queue along with all other packets. In some embodiments, the NAK packet may be given a higher priority so as to be moved to the head of a transmission queue.

By comparison, if a system were to wait for a data link layer protocol to determine that a frame of data was missing, the latency would be considerably larger. For example, as previously discussed, in the embodiment shown, a protocol is in use that provides for a user to transmit, in turn, once every 300 milliseconds. This latency time of 300 milliseconds is significantly longer than the tens of microseconds that it would take the present invention to determine that a frame needs to be retransmitted.

Conclusion

Embodiments of the present invention provide for reducing the time required to request a retransmission of missing, or errored, data. By initiating an ARQ process at a lower level of the communication process, this latency is reduced. Embodiments of the present invention may be included in a wide variety of wireless communications systems.

By determining that data has not been properly received, a receiving device can request retransmission of the data. In this manner, latency time can be improved by reducing the delay in notification to a transmitting unit that the data must be retransmitted.

The present invention can be embodied in the form of methods as well as apparatus for practicing those methods. The present invention can also be embodied in the form of program code embodied in tangible media, such as punched cards, magnetic tape, floppy disks, hard disk drives, CD-ROMs, flash memory cards, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It is to be understood that the present invention is not limited to the embodiments described above, but encompasses any and all embodiments within the scope of the subjoined claims.

What is claimed is:

1. A method of message communication, comprising:
transmitting a first message portion having a first characteristic; and
transmitting a second message portion having a second characteristic;
wherein the first characteristic provides a first probability of successful reception, and the second characteristic provides a second probability of successful reception.

2. The method of claim 1, wherein the first characteristic is a first power level, the second characteristic is a second power level, and the first power level is different from the second power level.

3. The method of claim 1, wherein the first probability is different from the second probability.

4. The method of claim 2, wherein the first message portion has a shorter duration than the second message portion.

5. The method of claim 2, wherein the first message portion is shorter than the second message portion; the first power level is greater than the second power level; and the first probability is greater than the second probability.

6. The method of claim 5, wherein the first message portion and the second message portion are associated with each other.

7. The method of claim 1, further comprising receiving a first set of information, the first set of information including an indication of successful receipt of the first message portion and unsuccessful receipt of the second message portion.

8. The method of claim 7, further comprising retransmitting at least the second message portion.

9. The method of claim 7, further comprising receiving a second set of information, the second set of information including an identifier of a last successfully received message.

10. The method of claim 9, further comprising retransmitting a plurality of previously transmitted message portions.

11. A method of message communication, comprising:
receiving, at a first time, a first message portion having a first energy per bit; and
receiving, at a second time, a second message portion having a second energy per bit, the second message portion being associated with the first message portion;
wherein the second time has a known temporal relationship to the first time.

12. The method of claim 11, wherein the first energy is different from the second energy.

13. The method of claim 11, wherein the first energy is greater than the second energy.

14. The method of claim 11, further comprising transmitting an acknowledgment message indicating that the second message portion was successfully received.

15. The method of claim 11, wherein the acknowledgment message includes a timestamp.

16. A method of message communication comprising:
receiving, at a first time, a first message portion having a first energy per bit; and
at a second time, receiving a signal from which a second message portion is not reliably obtained, the second message portion being associated with the first message portion;
wherein the second time has a known temporal relationship to the first time.

17. The method of claim 16, further comprising transmitting a first set of information, the first set of information including an indication of successful receipt of the first message portion and unsuccessful receipt of the second message portion.

18. The method of claim 17, further comprising transmitting a second set of information, the set of information including an identifier of a last successfully received message.

19. The method of claim 18, wherein transmitting the second set of information occurs time contiguously with transmitting the first set of information.

20. The method of claim 18, wherein the identifier of the last successfully received message includes a timestamp.

21. A method of communication, comprising:
transmitting at least one first message portion at a first energy per bit;
transmitting at least one second message portion at a second energy per bit;
receiving a request for retransmission of at least one second message portion; and
retransmitting the requested at least one second message portion at a third energy per bit;
wherein each second message portion is associated with a corresponding first message portion, and the third energy per bit is greater that the second energy per bit.

22. The method of claim 21, wherein transmitting at least one second message portion is performed subsequent to transmitting at least one first message portion.

23. Apparatus for message communication, comprising:
means for transmitting a first message portion having a first characteristic; and
means for transmitting a second message portion having a second characteristic;
wherein the first characteristic provides a first probability of successful reception, and the second characteristic provides a second probability of successful reception.

24. The apparatus of claim 23, wherein the first characteristic is a first power level, the second characteristic is a second power level, and the first power level is different from the second power level.

25. The apparatus of claim 23, wherein the first probability is different from the second probability.

26. The apparatus of claim 24, wherein the first message portion is configured with a shorter duration than the second message portion.

27. The apparatus of claim 24, wherein the first message portion is configured to be shorter than the second message portion; the first power level is configured to be greater than the second power level; and the first probability is greater than the second probability.

28. The apparatus of claim 27, wherein the first message portion and the second message portion are associated with each other.

29. The apparatus of claim 23, further comprising means for receiving a first set of information including an indication of successful receipt of the first message portion and unsuccessful receipt of the second message portion.

30. The apparatus of claim 29, further comprising means for retransmitting at least the second message portion.

31. The apparatus of claim 29, further comprising means for receiving a second set of information, the second set of information including an identifier of a last successfully received message.

32. The apparatus of claim 31, further comprising means for retransmitting a plurality of previously transmitted message portions.

33. Apparatus for message communication, comprising:
means for receiving, at a first time, a signal having a first message portion having a first energy per bit; and
means for receiving, at a second time, a signal having a second message portion having a second energy per bit, the second message portion being associated with the first message portion;
wherein the second time has a known temporal relationship to the first time.

34. The apparatus of claim 33, wherein the first energy is configured to be different from the second energy.

35. The apparatus of claim 33, wherein the first energy is configured to be greater than the second energy.

36. The apparatus of claim 33, further comprising means for transmitting an acknowledgment message indicating that the second message portion was successfully received.

37. The apparatus of claim 33, wherein the acknowledgment message is configured to include a timestamp.

38. Apparatus for message communication comprising:
means for receiving a signal, at a first time, having a first message portion with a first energy per bit; and
means for receiving a signal, at a second time, from which a second message portion is not reliably obtained, the second message portion being associated with the first message portion;
wherein the second time has a known temporal relationship to the first time.

39. The apparatus of claim 38, further comprising means for transmitting a first set of information, the first set of information including an indication of successful receipt of the first message portion and unsuccessful receipt of the second message portion.

40. The apparatus of claim 39, further comprising means for transmitting a second set of information, the set of information including an identifier of a last successfully received message.

41. The apparatus of claim 40, wherein transmitting the second set of information occurs time contiguously with transmitting the first set of information.

42. The apparatus of claim 40, wherein the identifier of the last successfully received message includes a timestamp.

43. Apparatus for communication, comprising:
means for transmitting at least one first message portion at a first energy per bit;
means for transmitting at least one second message portion at a second energy per bit;
means for receiving a request for retransmission of at least one second message portion; and
means for retransmitting the requested at least one second message portion at a third energy per bit;
wherein each second message portion is associated with a corresponding first message portion, and the third energy per bit is greater that the second energy per bit.

44. The apparatus of claim 43, configured to transmit at least one second message portion subsequent to transmitting at least one first message portion.
